(19) United States
(12) Patent Application Publication
(10) Pub. No.: US 2012/0290761 A1
(43) Pub. Date: Nov. 15, 2012

(54) USB Converter and Related Method

(76) Inventors: Jui-Yen Chen, Changhua County (TW); Chun-Yu Hsieh, New Taipei City (TW); Wen-Jeng Fang, Taipei City (TW)

(21) Appl. No.: 13/104,036

(22) Filed: May 10, 2011

(51) Int. Cl. G06F 13/14

(52) U.S. Cl. 710/305

(57) ABSTRACT

A Universal Serial Bus (USB) converter used in a USB system comprises at least one USB package processing unit and a processor. Each USB package processing unit is for receiving input packets from a corresponding first USB device according to a first protocol, converting the input packets into output packets of a second protocol, and outputting the output packets to a second USB device according to the second protocol. The processor is for selectively placing each USB package processing unit of the at least one USB package processing unit in a standby mode according to a corresponding detection signal indicating detected electrical state of a corresponding pin of the USB system connected to the corresponding first USB device.

### BACKGROUND

The disclosure relates to Universal Serial Bus (USB) conversion, and more particularly to a USB converter, and related method.

Universal Serial Bus (USB) specification 2.0 has transfer speed of 480 Mbps, and maximum output current of 500 mA. In many cases, the 500 mA of current supplied by a single USB 2.0 port is insufficient for powering peripheral devices, such as external hard disk drives (HDDs). One solution is to use a Y-cable to draw power from two USB ports, but this takes up an extra USB port. Another solution is an external alternating current (AC) adapter, but this adds extra weight to the device, making the peripheral cumbersome, and also increases the chance that the user will forget or lose the AC adapter, rendering the peripheral device useless until a replacement is found.

Universal Serial Bus (USB) specification 3.0 improves over USB 2.0 with transfer speed increased from 480 Mbps to 5 Gbps, output current increased from 500 mA to 900 mA, and more available power management modes. However, USB 2.0 devices are still prevalent, and pin configurations are different for USB 2.0 devices and USB 3.0 devices. Thus, when a USB device is connected to a USB 3.0 host, a handshake process must be performed to identify the USB device as either a USB 2.0 device or a USB 3.0 device. The handshake process is slow, which wastes time, and frustrates the user. Further, although USB 3.0 devices are compatible with USB 2.0 devices, when a USB 3.0 device is connected to a USB 2.0 device, the devices communicate in USB 2.0 mode, such that the higher output current and faster transfer speed of USB 3.0 cannot be used.

### SUMMARY

According to an embodiment, a Universal Serial Bus (USB) converter used in a USB system comprises at least one USB package processing unit and a processor. Each USB package processing unit is for receiving input packets of a first protocol from a corresponding first USB device, converting the input packets into output packets of a second protocol, and outputting the output packets to a second USB device. The processor is for selectively placing each USB package processing unit of the at least one USB package processing unit in a standby mode according to a detection signal indicating the first USB device uses the first protocol. The detection signal is generated according to electrical state of at least one pin of the USB system coupled to a corresponding pin of the first USB device.

According to an embodiment, a Universal Serial Bus (USB) connector system comprises at least one USB port for receiving a first USB signal according to a first protocol or a second USB signal according to a second protocol from a first USB device, a controller coupled to a first set of pins of the at least one USB port for receiving the first USB signal, and a converter coupled to a second set of pins of the at least one USB port and to the controller for converting the second USB signal to a third USB signal according to the first protocol, then transmitting the third USB signal to the controller.

According to an embodiment, a method of operating a Universal Serial Bus (USB) converter of a USB system comprises a USB device plugging into a USB port of the USB system, the USB converter detecting electrical state of a pin of the USB port to generate a detection signal, determining whether the USB device is a USB 2.0 device or a USB 3.0 device according to the detection signal, and the USB converter entering an active mode when the detection signal indicates that the USB device is a USB 2.0 device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a USB system with conversion functionality according to an embodiment.

FIG. 2 is a diagram of an embodiment of the USB converter of FIG. 1.

FIG. 3 is a flowchart of a process for use with the USB system of FIG. 1.

FIG. 4 is a diagram of a USB system according to another embodiment.

### DETAILED DESCRIPTION

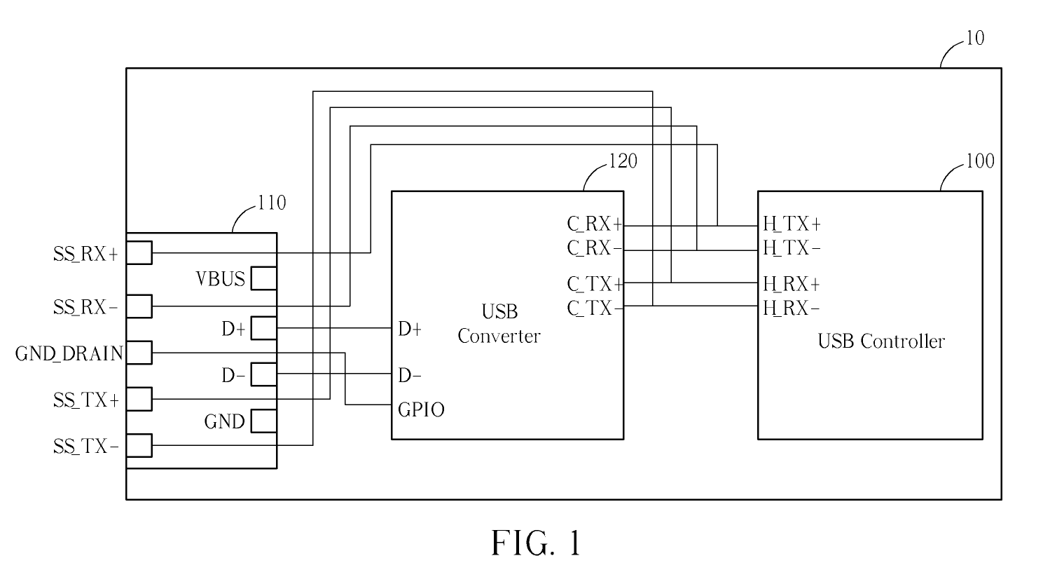

Please refer to FIG. 1, which is a diagram illustrating a USB system 10 with conversion functionality according to an embodiment. The USB system 10 as shown comprises a USB controller 100, a USB port 110, and a USB converter 120. The USB system 10 may be a USB host device connector system, a USB client connector system, a USB hub, etc. The USB controller 100 may be a USB 3.0 controller or a hybrid interface controller, and includes controller receive terminals H_RX+, H_RX− and controller transmit terminals H_TX+, H_TX−. The USB port 110 may be a USB 3.0 port, and includes USB 2.0 data pins D+, D−, USB power/ground pins VBUS, GND, USB 3.0 receive pins SS_RX+, SS_RX−, USB 3.0 transmit pins SS_TX+, SS_TX−, and a USB 3.0 ground pin GND_DRAIN. The controller receive terminals H_RX+, H_RX− and controller transmit terminals H_TX+, H_TX− of the USB controller 100 are coupled directly to the USB 3.0 transmit pins SS_TX+, SS_TX− and the USB 3.0 receive pins SS_RX+, SS_RX− of the USB port 110, respectively, as shown in FIG. 1. Thus, if a USB 3.0 device is plugged into the USB system 10, the USB 3.0 device performs USB 3.0 data communication directly with the USB controller 100, effectively bypassing the USB converter 120. The USB converter 120 does not perform signal conversion on signals transmitted by the USB 3.0 device.

The USB converter 120 may be configured to perform conversion from USB 2.0 to USB 3.0, and from USB 3.0 to USB 2.0, and includes converter data terminals D+, D− coupled to the USB 2.0 data pins D+, D−, converter transmit terminals C_TX+, C_TX− coupled to the host receive terminals H_RX+, H_RX−, and converter receive terminals C_RX+, C_RX− coupled to the host transmit terminals H_TX+, H_TX−. As shown in FIG. 1, the USB converter 120 receives USB 2.0 data signals from the data pins D+, D− of the USB port 110, converts the USB 2.0 data signals to USB 3.0 data signals, and transmits the USB 3.0 data signals to the USB host controller 100 through the converter transmit terminals C_TX+, C_TX−. The USB converter 120 may also receive USB 3.0 data signals from the USB controller 100 through the converter receive terminals C_RX+, C_RX−, convert the USB 3.0 data signals to USB 2.0 data signals, and transmit the USB 2.0 data signals to the data pins D+, D− of the USB port 110. Thus, when the USB 2.0 device is plugged into the USB system 10, the USB converter 120 located between the USB 2.0 device and the USB 3.0 controller 100 performs signal conversion between USB 2.0 signals and USB 3.0 signals (and vice versa), such that the USB 3.0 controller 100 effectively sees the USB 2.0 device as a USB 3.0 device, and communicates with the USB 2.0 device according to USB 3.0 protocols.

From the above description, it can be seen that the USB system 10 is configured in such a way that both USB 2.0 devices and USB 3.0 devices are seen by the USB 3.0 controller 100 as USB 3.0 devices when plugged into the system, and the USB 3.0 controller also communicates with plugged in USB devices (USB 2.0 or USB 3.0) according to USB 3.0 protocols. Thus, in addition to being able to provide up to 900 mA of current to both USB 2.0 and 3.0 devices, the USB 3.0 controller 100 can also employ more power management modes.

The USB converter 120 may further comprise a general purpose input/output (GPIO) terminal coupled to the USB 3.0 ground pin GND_DRAIN of the USB port 110 for detecting electrical state thereof, for example voltage level thereof, then determining whether the USB device is a USB 2.0 device or a USB 3.0 device and to enter an active mode or a standby mode. The USB 3.0 ground pin GND_DRAIN of the USB port 110 as well as the GPIO terminal are both grounded when a USB 3.0 device is connected to the USB port 110 due to being coupled to the GND_DRAIN pin of the USB 3.0 device, or both floating when a USB 2.0 device is connected to the USB port 110 due to there being no signal received from the GND_DRAIN pin of the USB port 110. The USB 3.0 ground pin GND_DRAIN of the USB port 110 may be initially set at a high voltage level through the GPIO terminal to aid in identification of the grounded/floating state. When a USB 2.0 device is plugged into the USB system 10, the USB 3.0 ground pin GND_DRAIN of the USB port 110 is floating, so the high voltage level remains, and the USB converter 120 operates in the active mode (components of the USB converter 120 related to performing conversion are turned on), and performs conversion to and from USB 3.0 between the USB controller 100 and the USB 2.0 device, so that the USB controller 100 may interface properly with the USB 2.0 device according to the USB 3.0 protocol. When a USB 3.0 device is plugged into the USB system 10, the USB 3.0 ground pin GND_DRAIN of the USB port 110 is grounded, so the voltage level is dropped, and the USB converter 120 enters the standby mode (components of the USB converter 120 related to performing conversion are turned off), which saves power, and the USB controller 100 interacts directly with the USB 3.0 device through coupling with the USB port 110, as shown in FIG. 1.

Although FIG. 1 shows a host configuration, the USB system 10 is also applicable to a hub configuration or a device configuration. When the USB system 10 is applied to a device configuration, the USB port 110 may be a USB plug, and the USB host controller may be a USB device controller.

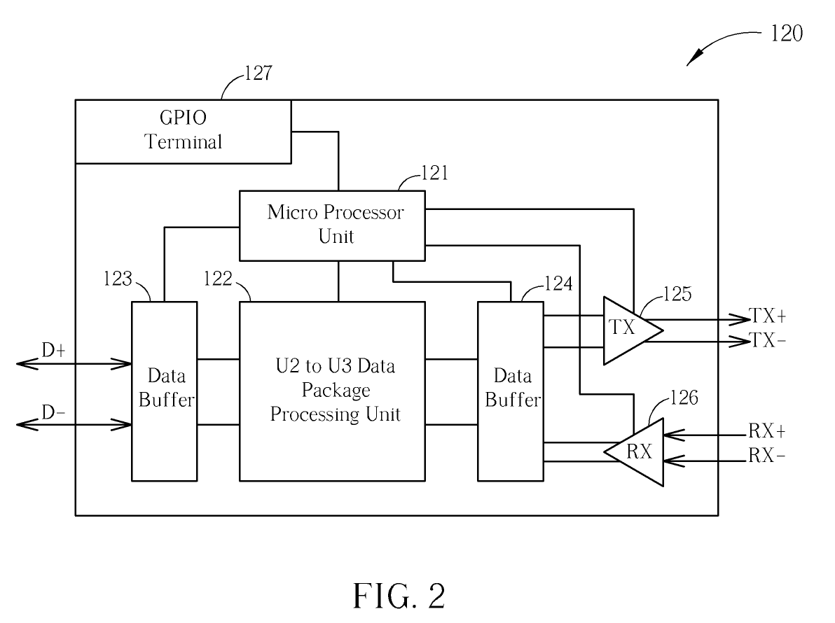

Please refer to FIG. 2, which is a diagram of an embodiment of the USB converter 120 of FIG. 1. The USB converter 120 comprises a microprocessor unit 121, a USB 2.0/3.0 data package processing unit 122, a port-side data buffer 123, a controller-side data buffer 124, a transmitter amplifier 125, a receiver amplifier 126, and a GPIO terminal 127. The port-side data buffer 123 is coupled to the USB 2.0 data pins D+, D− and the USB 2.0/3.0 data package processing unit 122, and stores USB 2.0 signals received from the USB port 110 and/or the USB 2.0/3.0 data package processing unit 122. The controller-side data buffer 124 is coupled to the controller receive and transmit terminals H_RX+, H_RX−, H_TX+, H_TX− and the USB 2.0/3.0 data package processing unit 122, and stores USB 3.0 signals received from the USB controller 100 and/or the USB 2.0/3.0 data package processing unit 122. The USB 2.0/3.0 data package processing unit 122 converts USB 2.0 data packages to USB 3.0 data packages, and converts USB 3.0 data packages to USB 2.0 data packages. The GPIO terminal 127 is coupled to the USB 3.0 ground pin GND_DRAIN of the USB port 110 for detecting the electrical state thereof, for example the voltage level thereof. The GPIO terminal 127 is further coupled to the microprocessor unit 121. A detection signal indicating whether the USB device coupled to the USB converter 120 is a USB 2.0 device or a USB 3.0 device is generated by detecting electrical state of the USB 3.0 ground pin GND_DRAIN of the USB port 110 through the GPIO terminal 127, and the detection signal is received by the microprocessor unit 121. The microprocessor unit 121 is coupled to, and configured for at least enabling and disabling, the USB 2.0/3.0 data package processing unit 122, the port-side data buffer 123, the host-side data buffer 124, the transmitter amplifier 125, and/or the receiver amplifier 126. The microprocessor unit 121 performs the disabling and enabling based on the detection signal received from the GPIO terminal 127. The microprocessor unit 121 may disable all or some of the USB 2.0/3.0 data package processing unit 122, the port-side data buffer 123, the controller-side data buffer 124, the transmitter amplifier 125, and the receiver amplifier 126 according to the detection signal. The disabling includes, but is not limited to, turning off, placing in standby, and/or placing in hibernation. For example, the microprocessor unit 121 may turn off a power supply supplying power to the amplifiers 125, 126, send disable signals to the data buffers 123, 124, and put the USB 2.0/3.0 data package processing unit 122 in a standby mode. The microprocessor unit 121 may also put itself in a standby mode, and await a change in the detection signal signaling that the USB converter 120 needs to come out of the standby mode, and make it enter an active mode.

In the above configuration, the USB converter 120 detects the electrical state of the USB 3.0 ground pin GND_DRAIN of the USB port 110 to determine whether to enter the active mode or the standby mode. In another embodiment where the USB converter 120 optionally does not include the GPIO terminal 127, the USB converter 120 may detect voltage level of either or both of the USB 2.0 data pins D+, D− to determine whether to enter the active mode or the standby mode. For example, when a USB 3.0 device is plugged into the USB port 110, the data pins D+, D− are floating, so the USB converter 120 enters the standby mode. When a USB 2.0 device is plugged into the USB port 110, the data pins D+, D− are non-floating, and the voltage level of the data pins D+, D− is either high or low, so the USB converter 120 enters an active mode. Detection of D+, D− pin electrical state may be performed during a handshake, and the electrical states of the D+, D− pins can be determined immediately based on whether or not the D+, D− pins are carrying a signal. When a USB 3.0 device is plugged in, the D+, D− pins are considered to not be carrying a signal. Detection of a sufficiently constant (sufficiently unchanging over a period of time) voltage level on the D+, D− pins is considered “not carrying a signal”. When a USB 2.0 device is plugged in, the D+, D− pins are considered to be carrying a signal. Detection of high and low voltage levels on the D+, D− pins is considered “carrying a signal”. Changes in the voltage levels on the D+, D− pins may be detected over a period of time, e.g. a few clock cycles according to the USB 2.0 specification. For example, a predetermined number of bits of a known handshake sequence may be identified to determine that the connected USB device is a USB 2.0 device.

In another embodiment, the USB converter 120 may be coupled to any, some, or all of the USB 3.0 transmit/receive pins SS_TX+, SS_TX−, SS_RX+, SS_RX−, and may detect electrical states of any, some, or all of the USB 3.0 transmit/receive pins SS_TX+, SS_TX−, SS_RX+, SS_RX− to determine whether to enter the active mode or the standby mode. In another embodiment, the USB converter 120 may detect electrical states of either or both of the USB 2.0 power/ground pins VBUS, GND to determine whether to enter the active mode or the standby mode.

Any combination or alteration of the above embodiments may also be utilized, e.g. detecting voltage levels of both the USB 3.0 ground pin GND_DRAIN and the USB 2.0 ground pin GND. Further, such detection is not limited to the USB converter 120, but may also be performed by the USB 3.0 controller 100. For example, the USB 3.0 controller 100 may detect signals on any, some, or all of the USB 3.0 transmit/receive pins SS_TX+, SS_TX−, SS_RX+, SS_RX− coupled thereto, and send a signal to the USB converter 120 indicating whether the USB device is a USB 2.0 device or a USB 3.0 device for the USB converter 120 determining to enter the active mode or the standby mode.

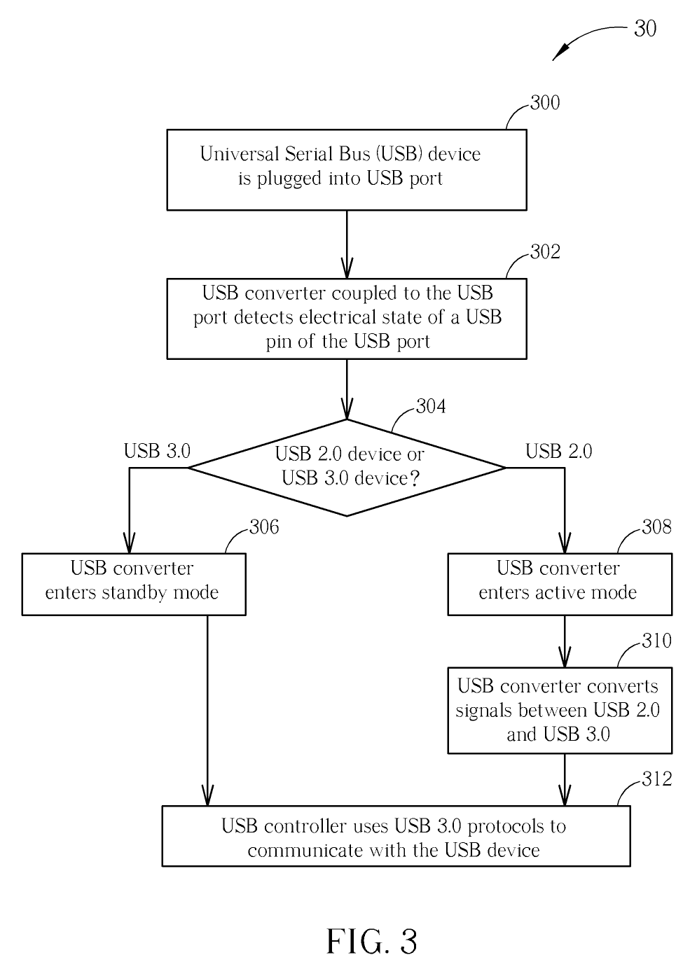

Please refer to FIG. 3, which is a flowchart of a process 30 for use with the USB system 10 of FIG. 1. The process 30 comprises the following steps:

Step 300: A USB device is plugged into a USB port of the USB system;

Step 302: A USB converter coupled to the USB port of the USB system detects electrical state of at least one USB pin of the USB port to determine the USB device is either a USB 2.0 or a USB 3.0 device;

Step 304: If the USB device is a USB 3.0 device, go to step 306; if the USB device is a USB 2.0 device, go to step 308;

Step 306: The USB converter enters a standby mode; go to step 312;

Step 308: The USB converter enters an active mode;

Step 310: The USB converter converts USB 2.0 signals to USB 3.0 signals, and USB 3.0 signals to USB 2.0 signals; and

Step 312: A USB controller of the USB system communicates with the USB device according to USB 3.0 protocols.

Initially, a USB 2.0 device or a USB 3.0 device is plugged into the USB port (Step 300). Upon the USB device being plugged in, the USB converter detects electrical state (e.g. voltage, current, floating, non-floating, carrying a signal, not carrying a signal) of one or more pins of the USB port (Step 302), as described above. Based on the electrical state detected by the USB converter, the USB converter enters the standby mode if the USB device is a USB 3.0 device (Step 306). If the USB device is a USB 2.0 device, the USB converter enters (or remains in) the active mode (Step 308).

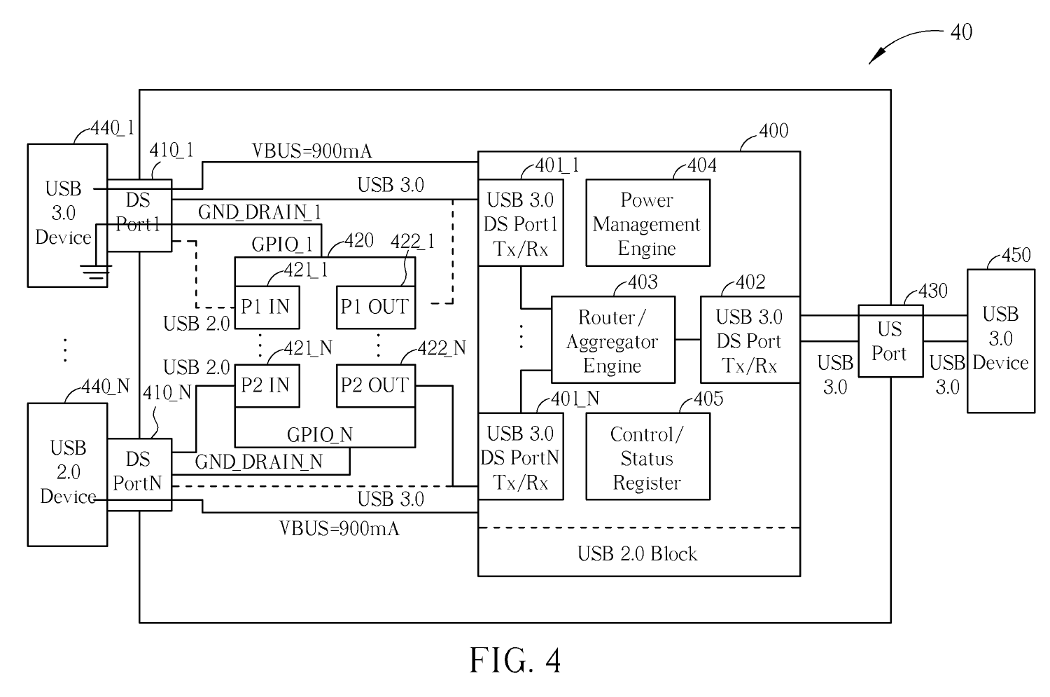

Please refer to FIG. 4, which is a diagram of a USB system 40 according to another embodiment. The USB system 40 may be a USB 3.0 hub, and comprises a USB hub controller 400, at least two downstream (DS) ports 410_1-410_N, a USB converter 420, and an upstream (US) port 430. A data connection provides USB 3.0 communication between the USB system 40 and a USB 3.0 host 450. The at least two downstream ports 410_1-410_N may each be coupled to a USB device. For illustrative purposes, FIG. 4 shows a USB 3.0 device 440_1 coupled to the DS port 410_1, and a USB 2.0 device 440_N coupled to the DS port 410_N.

The USB hub controller 400 further comprises a USB 3.0 US port transceiver 402 coupled to the US port 430. The USB hub controller 400 may further comprise at least a router/aggregator engine 403, a power management engine 404, and a control/status register 405. The router/aggregator engine 403 is coupled to the at least two USB 3.0 DS port transceivers 401_1-401_N, and to the USB 3.0 US port transceiver 402 for directing flow of packets between the at least two USB 3.0 DS port transceivers 401_1-401_N and the USB 3.0 US port transceiver 402. The power management engine 404 controls various power management modes of the USB host controller 400. The control/status register 405 controls behavior of the USB host controller 400, and also provides status information of the USB host controller 400. The USB 3.0 US port transceiver 402 is coupled to the US port 430 for communicating with the US port 430 in USB 3.0 mode.

The USB converter 420 comprises a plurality of converter units similar to the USB converter 120. The USB converter 420 comprises at least two input terminals 421_1-421_N, each input terminal coupled to a corresponding DS port of the at least two DS ports 410_1-410_N. The USB converter 420 further comprises at least two output terminals 422_1-422_N, each output terminal coupled to a corresponding DS port transceiver of at least two USB 3.0 DS port transceivers 401_1-401_N of the USB hub controller 400. The USB converter 420 may further comprise at least two corresponding GPIO terminals GPIO_1-GPIO_N. In the USB converter 420, each GPIO terminal GPIO_1-GPIO_N is part of a corresponding converter unit, and is used to detect electrical state of one or more pins of each DS port 410_1-410_N coupled to the corresponding USB device 440_1-440_N. Operation of each converter unit is the same as that of the USB converter 120. Each converter unit is capable of entering a standby mode or an active mode independently of other converter units in the USB converter 420 to provide conversion from USB 2.0 to USB 3.0 and vice versa. For each USB 3.0 device connected to the USB system 40, the corresponding converter unit of the USB converter 420 operates in the standby mode, and for each USB 2.0 device connected to the USB system 40, the corresponding converter unit of the USB converter 420 operates in the active mode. For example, as shown in FIG. 4, when the USB 3.0 device 440_1 is coupled to the USB 3.0 DS port transceiver 410_1, the corresponding converter unit of the USB converter 420 (from the input terminal 421_1 to the output terminal 422_1) operates in the standby mode (dashed lines indicate no conversion is performed), and when the USB 2.0 device 440_N is coupled to the USB 3.0 DS port transceiver 410_N, the corresponding converter unit of the USB converter 420 (from the input terminal 421_N to the output terminal 422_N) operates in the active mode, and the corresponding USB 3.0 pins of the USB 3.0 DS port transceiver 410_N are floating (indicated by dashed line from DS port 410_N to DS port transceiver 401_N).

In the USB system 40, the USB hub can use each converter unit of the USB converter 420 to couple to the D+, D− pins of each connected USB device to determine whether the USB device is a USB 2.0 device or a USB 3.0 device according to the electrical state of the D+, D− pins of the DS ports 410_1-410_N, or include GPIO terminals coupled to the GND_DRAIN pins of each DS port 410_1-410_N to determine whether the USB device is a USB 2.0 device or a USB 3.0 device. The GPIO terminals provide immediate detection, and do not rely on the handshake process, and identification can be performed more directly and rapidly. Thus, if the USB system is realized as a USB 3.0 hub, the system can convert all USB 2.0 signals of all connected USB 2.0 devices to USB 3.0 signals for communication with the USB 3.0 host, and thereby provide higher speed and more power, as well as more power management options, when interacting with the USB 2.0 device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A Universal Serial Bus (USB) converter used in a USB system, the USB converter comprising:
at least one USB package processing unit, each USB package processing unit for receiving input packets of a first protocol from a corresponding first USB device, converting the input packets into output packets of a second protocol, and outputting the output packets to a second USB device; and
a processor for selectively placing each USB package processing unit of the at least one USB package processing unit in a standby mode according to a detection signal indicating the first USB device uses the second protocol, wherein the detection signal is generated according to electrical state of at least one pin of the USB system coupled to a corresponding pin of the first USB device.

2. The USB converter of claim 1, wherein the first protocol is USB 2.0, and the second protocol is USB 3.0.

3. The USB converter of claim 1, wherein the processor takes the USB package processing unit out of the standby mode, and places the USB package processing unit in an active mode when the first USB device uses the first protocol.

4. The USB converter of claim 3, wherein the at least one pin of the USB system is coupled to a USB 2.0 data pin of the first USB device.

5. The USB converter of claim 4, wherein the processor takes the USB package processing unit out of the standby mode, and places the USB package processing unit in an active mode when the USB 2.0 data pin carries a signal.

6. The USB converter of claim 1, wherein the detection signal is generated according to an electrical state of at least one GND_DRAIN pin of the USB system coupled to a corresponding general purpose input/output (GPIO) terminal of the USB converter.

7. The USB converter of claim 6, wherein the processor places the corresponding USB package processing unit in the standby mode when the electrical state of the at least one GND_DRAIN pin is grounded.

8. The USB converter of claim 6, wherein the processor places the corresponding USB package processing unit in an active mode when the electrical state of the at least one GND_DRAIN pin is floating.

9. A Universal Serial Bus (USB) connector system, comprising:
at least one USB port for receiving a first USB signal according to a first protocol or a second USB signal according to a second protocol from a first USB device;
a controller coupled to a first set of pins of the at least one USB port for receiving the first USB signal; and
a converter coupled to a second set of pins of the at least one USB port and to the controller for converting the second USB signal to a third USB signal according to the first protocol, then transmitting the third USB signal to the controller.

10. The USB connector system of claim 9, wherein the first protocol is USB 3.0 protocol, and the second protocol is USB 2.0 protocol.

11. The USB connector system of claim 9, wherein the converter is activated according to a detection signal indicating the first USB device uses the first protocol, wherein the detection signal is generated according to an electrical state of at least one pin of the USB port coupled to a corresponding pin of the first USB device.

12. The USB connector system of claim 11, wherein the detection signal is generated by detecting an electrical state of the at least one pin of the USB port coupled to at least one data pin of the first USB device.

13. The USB connector system of claim 11, wherein the converter further comprises at least one general purpose input/output (GPIO) terminal, each GPIO terminal coupled to a corresponding GND_DRAIN pin of the at least one USB port, and the detection signal is generated by detecting at least one electrical state of the at least one GND_DRAIN pin through the at least one GPIO terminal.

14. The USB connector system of claim 13, wherein the converter is not activated and enters a standby mode when the electrical states of the at least one GND_DRAIN pins are all grounded.

15. The USB connector system of claim 13, wherein the converter is activated when any electrical state of the at least one GND_DRAIN pin is floating.

16. A method of operating a Universal Serial Bus (USB) converter of a USB system, the method comprising:
a USB device plugging into a USB port of the USB system;
the USB converter detecting electrical state of a pin of the USB port to generate a detection signal;
determining whether the USB device is a USB 2.0 device or a USB 3.0 device according to the detection signal; and
the USB converter entering an active mode when the detection signal indicates that the USB device is a USB 2.0 device.

17. The method of claim 16, wherein the USB converter detecting the electrical state of the pin of the USB port to generate the detection signal is the USB converter detecting an electrical state of a USB 2.0 data pin of the USB port to generate the detection signal.

18. The method of claim 16, wherein the USB converter detecting the electrical state of the pin of the USB port to generate the detection signal is the USB converter detecting an electrical state of a GND_DRAIN pin of the USB port through a general purpose input/output (GPIO) terminal to generate the detection signal.

19. The method of claim 18, wherein the USB converter entering the active mode when the detection signal indicates that the USB device is the USB 2.0 device is the USB converter entering the active mode when the detection signal is generated by the GND_DRAIN pin not being grounded.

20. The method of claim 16, further comprising:
the USB converter leaving the active mode and entering a standby mode when the detection signal indicates that the USB device is a USB 3.0 device.
